(19) United States
(12) Patent Application Publication
(10) Pub. No.: US 2025/0209093 A1
(43) Pub. Date: Jun. 26, 2025

(54) ELECTRONIC DEVICE FOR GENERATING METADATA AND METHOD OF OPERATING THE SAME

(71) Applicant: Electronics and Telecommunications Research Institute, Daejeon (KR)

(72) Inventors: Marie KIM, Daejeon (KR); IL Woo LEE, Daejeon (KR); Tae-Wook HEO, Daejeon (KR)

(21) Appl. No.: 18/945,895

(22) Filed: Nov. 13, 2024

(30) Foreign Application Priority Data
Dec. 26, 2023 (KR) 10-2023-0191084

(51) Int. Cl. G06F 16/28; G06F 16/26

(52) U.S. Cl. CPC G06F 16/287; G06F 16/26

(57) ABSTRACT

An electronic device for generating metadata and a method of operating the same are provided. The method includes obtaining data related to energy used in a factory, obtaining information about a node related to an attribute of the data and information about an edge between nodes from a metadata model predefined for the data, generating metadata for managing the data using the information about the node and the information about the edge, and visualizing and outputting the metadata.

### CROSS-REFERENCE TO RELATED APPLICATION

This application claims the benefit of Korean Patent Application No. 10-2023-0191084, filed on Dec. 26, 2023, in the Korean Intellectual Property Office, the entire disclosure of which is incorporated herein by reference for all purposes.

### BACKGROUND

### 1. Field of the Invention

The following description relates to an electronic device for generating metadata and a method of operating the same.

### 2. Description of the Related Art

As the amount of data to be processed increases and becomes more complex, studies on metadata are being conducted for efficient data management. Metadata technology may refer to technology of generating and managing metadata, which is contextual information described about obtained data. By giving meaning to and describing information assets of organizations and entities, metadata may enhance the value of data by improving usability and search feasibility of data.

In addition, metadata may also provide a context required to understand and manage systems, data, and businesses. Metadata may help understand obtained data and gain insights through efficient data search.

Data catalog technology may refer to technology of managing data or metadata and providing a user with information within the data or metadata. Data catalog technology may require different metadata models depending on a domain of metadata.

A factory energy management system (FEMS) may refer to a management system for efficiently managing energy consumed in a factory to reduce energy waste and improve profits. The FEMS may obtain data related to energy from a factory in real time and may manage the data. The data obtained from the FEMS may be stored in the form of a silo and may be provided as a monitoring result.

### SUMMARY

Since the number of items of obtained data and the amount of data are large, a factory energy management system (FEMS) may require a lot of costs and time for obtaining, processing, and storing data.

According to various embodiments, metadata for managing data related to energy utilized in a factory may be generated.

According to various embodiments, metadata may be generated by obtaining information about a node related to attributes of data and an edge between nodes, from a metadata model.

According to various embodiments, metadata may be visualized and output for data management in a factory.

Other objects and advantages of the present disclosure can be understood by the following description and will become more apparent by the embodiments of the present disclosure. In addition, it will be apparent that the objects and advantages of the present disclosure can be readily realized by the means and combinations thereof recited in the claims.

According to an aspect, there is provided a method of operating an electronic device, the method including obtaining data related to energy used in a factory, obtaining information about a node related to an attribute of the data and information about an edge between nodes from a metadata model predefined for the data, generating metadata for managing the data using the information about the node and the information about the edge, and visualizing and outputting the metadata.

The generating of the metadata may include determining the node and the edge based on the attribute of the data and generating the metadata using the node and the edge.

The generating of the metadata may include determining the node based on the attribute of the data using the information about the node and determining the edge between related nodes, based on a relationship between the information about the edge and the attribute of the data between the nodes.

The generating of the metadata may include determining statistical information about the data and generating the metadata including the statistical information.

The generating of the metadata may include determining energy efficiency of the factory from the data and generating the metadata including the energy efficiency.

The generating of the metadata may include generating the metadata by classifying the metadata into dynamic metadata in which a value changes over time or static metadata using the data.

The visualizing and outputting of the metadata may include outputting information about the energy by equipment of the factory using the metadata.

The data may include information about an observation point on equipment of the factory and energy obtained from the observation point.

The data may include information about at least one of equipment of the factory, an observation point on the equipment, or an item obtained from the observation point.

The data may include information with a standardized structure based on an observation point on equipment of the factory.

According to another aspect, there is provided an electronic device including a processor configured to obtain data related to energy used in a factory, obtain information about a node related to an attribute of the data and information about an edge between nodes from a metadata model predefined for the data, generate metadata for managing the data using the information about the node and the information about the edge, and visualize and output the metadata.

The processor may be further configured to determine the node and the edge based on the attribute of the data and generate the metadata using the node and the edge.

The processor may be further configured to determine the node based on the attribute of the data using the information about the node and determine the edge between related nodes, based on a relationship between the information about the edge and the attribute of the data between the nodes.

The processor may be further configured to determine statistical information about the data and generate the metadata including the statistical information.

The processor may be further configured to determine energy efficiency of the factory from the data and generate the metadata including the energy efficiency.

The processor may be further configured to generate the metadata by classifying the metadata into dynamic metadata in which a value changes over time or static metadata using the data.

The processor may be further configured to output information about the energy by equipment of the factory using the metadata.

The data may include information about an observation point on equipment of the factory and energy obtained from the observation point.

The data may include information about at least one of equipment of the factory, an observation point on the equipment, or an item obtained from the observation point.

The data may include information with a standardized structure based on an observation point on equipment of the factory.

Additional aspects of embodiments will be set forth in part in the description which follows and, in part, will be apparent from the description, or may be learned by practice of the disclosure.

According to various embodiments, metadata may be generated and provided to facilitate management and analysis of data obtained from an FEMS, provide full contextual information of the data, and support efficient search.

According to various embodiments, energy waste and greenhouse gas emissions may be reduced by visualizing and outputting metadata for data management in a factory.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a structure in which a metadata model obtains data, according to an embodiment;

FIG. 2 is a diagram illustrating a classification of metadata generated by an electronic device, according to an embodiment;

FIG. 3 is a diagram illustrating an operation of generating metadata by an electronic device and providing a data catalog service, according to an embodiment;

FIG. 4 is a schematic flowchart of an electronic device for generating metadata, according to an embodiment; and

FIG. 5 is a schematic block diagram of an electronic device for generating metadata, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

As used herein, “A or B”, “at least one of A and B”, “at least one of A or B”, “A, B or C”, “at least one of A, B and C”, “at least one of A, B, or C”, and “one or a combination of at least two of A, B, and C,” each of which may include any one of the items listed together in the corresponding one of the phrases, or all possible combinations thereof. Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, the embodiments will be described in detail with reference to the accompanying drawings. When describing the embodiments with reference to the accompanying drawings, like reference numerals refer to like components and a repeated description related thereto will be omitted.

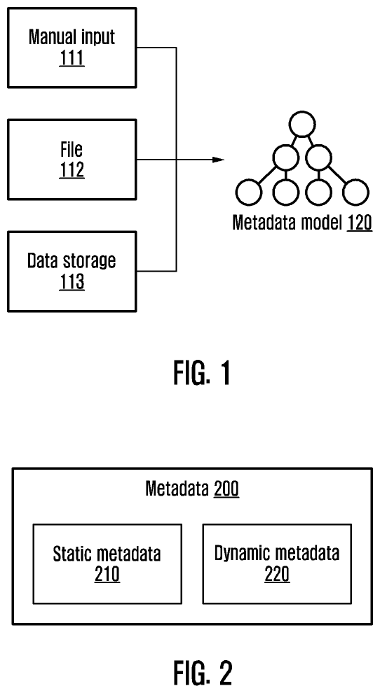

FIG. 1 is a diagram illustrating a structure in which a metadata model obtains data, according to an embodiment.

Referring to FIG. 1, an example of a structure in which a metadata model 120 obtains data related to energy utilized in a factory through manual input 111, a file 112, or a data storage 113 is illustrated.

According to an embodiment, an electronic device for generating metadata may include a factory energy management system (FEMS) for obtaining data.

The FEMS may collect and manage data based on an observation point on equipment of the factory, and the collected data may be stored in a local server or a cloud server. The observation point may be added or replaced, or a location name may be changed, as needed during a factory operation. In other words, data included in metadata may be added, modified, or deleted during the factory operation.

When the data is added, modified, or deleted, the data may be updated through the manual input 111 or if necessary, through upload of the file 112. The metadata representing a state or a utilization state of obtained data may be continuously updated or may be automatically updated based on a set value.

The metadata model 120 may obtain the data through the file 112 to generate the metadata. For example, the metadata model 120 may obtain the data through the file 112 in the form of a spreadsheet (e.g., an Excel spreadsheet). In addition, a configuration of the file 112 may be standardized to automate data processing. According to an embodiment, a name of the file 112 and a structure of contents included in the file 112 may be standardized based on the observation point of the factory. For example, when the file 112 is in the form of a spreadsheet, the file 112 may have standardized names and may be classified into major sheets according to a sheet in which tag values of the observation point are set and described, a sheet including contents about the type, location, or related equipment for each observation point, a sheet including process information related to each piece of equipment or observation point, a sheet including a structure and description of obtained information, and the like. In addition, the file 112 may be standardized in structure according to names of columns included in each sheet, types of data values, types of information obtained from relevant processes and equipment for each observation point, names of equipment used for each process, protocols involved in obtaining the data, protocols for obtaining the stored data, standard notation for a uniform resource locator (URL) for accessing the stored data, and the like.

The metadata model 120 may obtain the data through the data storage 113 to generate the metadata. The data storage 113 may store and provide the data obtained from the observation point. In addition, the data storage 113 may also determine and provide statistical information from the obtained data.

The metadata model 120 may be utilized to generate the metadata by using the data obtained through the manual input 111, the file 112, or the data storage 113. The metadata model 120 may include information about major nodes and minor nodes (e.g., attributes of the data) of metadata and information about edges between the nodes.

FIG. 2 is a diagram illustrating a classification of metadata generated by an electronic device, according to an embodiment.

Referring to FIG. 2, an example of static metadata 210 and dynamic metadata 220 is shown as classifications of metadata 200.

The static metadata 210 may include data in which a data value may be used through reading once the data value is entered, but the value may be modified due to field conditions or operational reasons. For example, the static metadata 210 may include tagging system information, information about data items, information about the observation point, and contents related to equipment, processes, and air conditioning. The data values in the static metadata 210 are immutable once set, but may be modified for operational purposes or other reasons. In the case of the FEMS, contents about installation and operation of infrastructure for obtaining the data may be organized and written in the form of a file through an agreement between an installer and an operator, and thus, the data values of the static metadata 210 may be set through the file.

The dynamic metadata 220 may include data in which a value changes over time, such as data views or data statistical values. In addition, the dynamic metadata 220 may utilize a meaningful representative value (e.g., energy efficiency information such as a predetermined period equipment or process) for dynamically collected data. The data in the dynamic metadata 220 may have a data value updated periodically or based on events.

A method such as manual input or file input may be utilized to generate and manage the static metadata 210, and a data storage may be utilized to generate and manage the dynamic metadata 220.

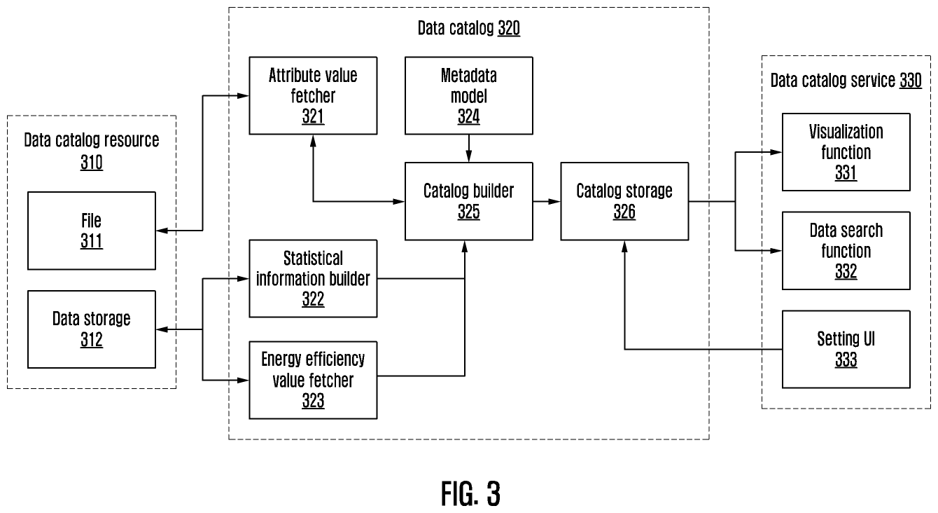

FIG. 3 is a diagram illustrating an operation of generating metadata by an electronic device and providing a data catalog service, according to an embodiment.

Referring to FIG. 3, an example of a structure for generating metadata and a data catalog 320 using a data catalog resource 310 and a metadata model 324 and providing a data catalog service 330 through the data catalog 320 generated is illustrated.

The data catalog resource 310 is a resource for generating the metadata and the data catalog 320 and may include a file 311 and a data storage 312.

A catalog builder 325 may transmit information about nodes and edges to an attribute value fetcher 321, a statistical information builder 322, and an energy efficiency value fetcher. When the metadata is generated from the file 311 in the form of a spreadsheet, a column name of the file 311 may be determined as a name of a node in the metadata model 324. In the metadata model 324, related nodes may be connected through edges to represent a relationship. In the case of a file in the form of a spreadsheet, different column names located in the same row may be related nodes.

The attribute value fetcher 321 may obtain an attribute value from the file 311. Using the obtained attribute value and the information about nodes and edges, the attribute value fetcher 321 may generate the metadata and transmit the metadata to the catalog builder 325. The catalog builder 325 may store the generated metadata in a catalog storage 326, based on the metadata model 324 that is predetermined. The metadata may be stored in a form that facilitates visualization or search based on the metadata model 324. For example, the metadata may be stored in the form of a resource description framework (RDF) or in another form.

Static metadata may be input manually through a setting user interface (UI) 333 or input through the file 311 and may be stored in the catalog storage 326. When the metadata is generated through the file 311, the electronic device may obtain the information about nodes and edges from the metadata model 324, which is predetermined, to generate the metadata.

In the case of dynamic metadata, the statistical information builder 322 may obtain data from the data storage 312 to determine statistical information (e.g., a minimum value, a maximum value, or an average value) about the data. Alternatively, the data storage 312 may determine the statistical information about the data and may transmit the statistical information to the statistical information builder 322. The data storage 312 may be located outside the data catalog 320. The data storage 312 may determine from which one of the data storage 312 or the data catalog 320 the statistical information is determined, how to set an update cycle of the statistical information, and how to determine updated information, considering security, privacy, cost, and utility in a domain. The value set by the data storage 312 may be predetermined and fixed, or may be changed dynamically through the setting UI 333. In the case of the statistical information builder 322 or the energy efficiency value fetcher 323 of a process or equipment, required data may be obtained from the data storage 312 to determine a required value or a result value may be obtained by making a request to the data storage 312. According to an embodiment, when other information is used, such as average carbon emissions, in addition to energy efficiency information as the dynamic metadata, the other information may also be generated as dynamic metadata and continuously managed as metadata in the same method as the energy efficiency value fetcher 323 to be provided to a user. According to an embodiment, the data catalog 320 may configure a dynamic metadata builder including the energy efficiency value fetcher 323, the statistical information builder 322, and the like, to generate one block dedicated to generation and management of dynamic metadata.

The data catalog service 330 may represent a service provided using a data catalog generated by the catalog builder 325. The data catalog service 330 may include a visualization function 331 and a data search function 332 and may be controlled by the setting UI 333 or a data value may be input to the catalog storage 326.

The data search function 332 may provide search functionality for the metadata stored in the catalog storage 326. A user may obtain information required for management or monitoring through data search. In addition, the data search function 332 may be utilized to provide the visualization function 331. The functions of the data catalog service 330 shown in FIG. 3 include the visualization function 331 and the data search function 332, for ease of description, but embodiments are not limited thereto and may further provide a variety of functions utilizing the metadata.

The visualization function 331 may visualize the generated metadata and may output the metadata as a data catalog. In addition, the visualization function 331 may provide information about available equipment by searching and visualizing equipment used in a same process for a same product. The visualization function 331 may search for and visualize energy efficiency information or greenhouse gas emissions information together for each piece of equipment or process in a factory to provide equipment information for a same process that may be more energy efficient or help reduce greenhouse gas emissions. The information described above may be visualized in the form of a network, a diagram, or a report. According to an embodiment, when the metadata includes information about a series of processes of making a product, the energy efficiency information for each process may be searched for and visualized together to identify the flow of energy efficiency over an entire cycle of the product production. The data catalog service 330 for metadata may be used to help design an alternative or optimal product production line for process equipment.

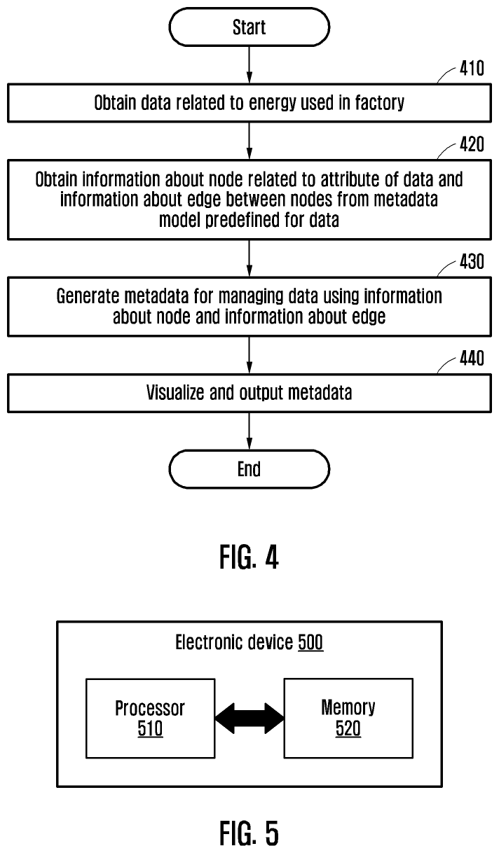

FIG. 4 is a schematic flowchart of an electronic device for generating metadata, according to an embodiment.

In the following embodiments, operations may be performed sequentially but not necessarily. For example, the order of the operations may change and at least two of the operations may be performed in parallel. Operations 410 to 440 may be performed by at least one component (e.g., a processor) of an electronic device.

In operation 410, the electronic device may obtain data related to energy used in a factory.

In operation 420, the electronic device may obtain information about a node related to an attribute of the data and information about an edge between nodes from a metadata model predefined for the data.

In operation 430, the electronic device may generate metadata for managing the data using the information about a node and the information about an edge. Based on the attribute of the data, the electronic device may determine nodes and edges and may generate the metadata using the nodes and edges. Using information about the nodes, the electronic device may determine the nodes according to the attribute of the data and may determine the edges between related nodes based on information about the edges and a relationship of attributes of the data between the nodes.

The electronic device may determine statistical information about the data to generate the metadata. The electronic device may determine energy efficiency of the factory from the data to generate the metadata. The electronic device may generate metadata by classifying the metadata into dynamic metadata in which a value changes over time and static metadata using the data.

In operation 440, the electronic device may visualize and output the metadata. Using the metadata, the electronic device may output information about energy for each piece of equipment in the factory.

The data may include information about an observation point on equipment of the factory and energy obtained from the observation point. The data may include information about at least one of equipment of the factory, an observation point on the equipment, or an item obtained from the observation point. The data may include information with a standardized structure based on an observation point on equipment of the factory.

FIG. 5 is a schematic block diagram of an electronic device for generating metadata, according to an embodiment.

Referring to FIG. 5, an electronic device 500 may include a processor 510. The processor 510 may include at least one processor. In addition, the electronic device 500 may further include a memory 520.

The memory 520 may store instructions (or programs) executable by the processor 510. For example, the instructions may include instructions for executing an operation of the processor 510 and/or an operation of each component of the processor 510.

The processor 510 may be a device that executes instructions or programs or controls the electronic device 500 and may include, for example, various processors such as a central processing unit (CPU) and a graphics processing unit (GPU). The processor 510 may obtain data related to energy used in a factory. The processor 510 may obtain information about a node related to an attribute of the data and information about an edge between nodes from a metadata model predefined for the data. The processor 510 may generate metadata for managing the data using the information about a node and the information about an edge. The processor 510 may visualize and output the metadata.

Based on the attribute of the data, the processor 510 may determine nodes and edges and may generate the metadata using the nodes and edges. Using information about the nodes, the processor 510 may determine the nodes according to the attribute of the data and may determine the edges between related nodes based on information about the edges and a relationship of attributes of the data between the nodes. The processor 510 may determine statistical information about the data to generate the metadata. The processor 510 may determine energy efficiency of the factory from the data to generate the metadata. The processor 510 may generate metadata by classifying the metadate into dynamic metadata in which a value changes over time and static metadata using the data. Using the metadata, the processor 510 may output information about energy for each piece of equipment in the factory.

The data may include information about an observation point on equipment of the factory and energy obtained from the observation point. The data may include information about at least one of equipment of the factory, an observation point on the equipment, or an item obtained from the observation point. The data may include information with a standardized structure based on an observation point on equipment of the factory.

In addition, the electronic device 500 may process the operations described above.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of operating an electronic device, the method comprising:
obtaining data related to energy used in a factory;
obtaining information about a node related to an attribute of the data and information about an edge between nodes from a metadata model predefined for the data;
generating metadata for managing the data using the information about the node and the information about the edge; and
visualizing and outputting the metadata.

2. The method of claim 1, wherein
the generating of the metadata comprises:
determining the node and the edge based on the attribute of the data; and
generating the metadata using the node and the edge.

3. The method of claim 1, wherein
the generating of the metadata comprises:
determining the node based on the attribute of the data using the information about the node; and
determining the edge between related nodes, based on a relationship between the information about the edge and the attribute of the data between the nodes.

4. The method of claim 1, wherein
the generating of the metadata comprises:
determining statistical information about the data; and
generating the metadata including the statistical information.

5. The method of claim 1, wherein
the generating of the metadata comprises:
determining energy efficiency of the factory from the data; and
generating the metadata including the energy efficiency.

6. The method of claim 1, wherein
the generating of the metadata comprises generating the metadata by classifying the metadata into dynamic metadata in which a value changes over time or static metadata using the data.

7. The method of claim 1, wherein
the visualizing and outputting of the metadata comprises outputting information about the energy by equipment of the factory using the metadata.

8. The method of claim 1, wherein
the data comprises information about an observation point on equipment of the factory and energy obtained from the observation point.

9. The method of claim 1, wherein
the data comprises information about at least one of equipment of the factory, an observation point on the equipment, or an item obtained from the observation point.

10. The method of claim 1, wherein
the data comprises information with a standardized structure based on an observation point on equipment of the factory.

11. An electronic device comprising:
a processor configured to:
obtain data related to energy used in a factory;
obtain information about a node related to an attribute of the data and information about an edge between nodes from a metadata model predefined for the data;
generate metadata for managing the data using the information about the node and the information about the edge; and
visualize and output the metadata.

12. The electronic device of claim 11, wherein
the processor is further configured to:
determine the node and the edge based on the attribute of the data; and
generate the metadata using the node and the edge.

13. The electronic device of claim 11, wherein
the processor is further configured to:
determine the node based on the attribute of the data using the information about the node; and
determine the edge between related nodes, based on a relationship between the information about the edge and the attribute of the data between the nodes.

14. The electronic device of claim 11, wherein
the processor is further configured to:
determine statistical information about the data; and
generate the metadata including the statistical information.

15. The electronic device of claim 11, wherein
the processor is further configured to:
determine energy efficiency of the factory from the data; and
generate the metadata including the energy efficiency.

16. The electronic device of claim 11, wherein
the processor is further configured to generate the metadata by classifying the metadata into dynamic metadata in which a value changes over time or static metadata using the data.

17. The electronic device of claim 11, wherein
the processor is further configured to output information about the energy by equipment of the factory using the metadata.

18. The electronic device of claim 11, wherein
the data comprises information about an observation point on equipment of the factory and energy obtained from the observation point.

19. The electronic device of claim 11, wherein
the data comprises information about at least one of equipment of the factory, an observation point on the equipment, or an item obtained from the observation point.

20. The electronic device of claim 11, wherein
the data comprises information with a standardized structure based on an observation point on equipment of the factory.
